(19) United States
(12) Patent Application Publication
(10) Pub. No.: US 2006/0290277 A1
(43) Pub. Date: Dec. 28, 2006

(54) Organic electroluminescent display device

(75) Inventors: Toshiro Takahashi, Kanagawa (JP); Masaya Nakayama, Kanagawa (JP); Tasuku Satou, Kanagawa (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD., Minami-Ashigara-shi (JP)

(21) Appl. No.: 11/441,207

(22) Filed: May 26, 2006

(30) Foreign Application Priority Data
May 27, 2005 (JP) 2005-155614

(51) Int. Cl. H01J 17/00

(52) U.S. Cl. 313/517

(57) ABSTRACT

The present invention provides an organic electroluminescent display device, comprising: pixels that are each divided into at least two segments; current supply lines each independently connected to each of the segments; and active elements that are provided per each pixel and control the connection between an organic electroluminescent element and a power supply line, wherein at least one connection line between a defective segment of the segments and the active element is cut.

### CROSS-REFERENCE TO RELATED APPLICATION

This application claims priority under 35 USC 119 from Japanese Patent Application No. 2005-155614, the disclosure of which is incorporated by reference herein.

### BACKGROUND OF THE INVENTION

1. Field of the Invention

The present invention relates to an organic electroluminescent display device and particularly to an active matrix organic electroluminescent display device characterized by a structure for recovering from a display defect caused by a short-circuit defect due to dust or residues associated with manufacturing processes.

2. Description of the Related Art

While in recent years, thin flat panel displays such as liquid crystal displays and plasma displays have been widely used as alternatives to CRTs, attention has recently been focused on organic electroluminescent (EL) displays among self-light-emitting flat panel displays.

The organic EL display comprises a large number of organic EL element pixels arranged in a matrix, and in the case of a full color display, each pixel comprises R, G and B sub-pixels.

The method of driving the organic EL element includes a passive matrix driving method and an active matrix driving method, like the case of liquid crystal displays. In particular, the active matrix driving method, in which an active element such as TFT is provided per each pixel to control the operation of the EL element, is considered as preferable for high picture quality.

In a voltage-driven liquid crystal display, a single TFT is used as a switching element and is directly connected to a pixel electrode. In a current-driven organic EL display, however, at least two, generally four to six TFTs and one or two capacitors are used.

A conventional organic EL display is described below with reference to FIGS. 12 to 14.

FIG. 12 is a circuit configuration diagram of a pixel circuit for a conventional organic EL display using TFTs. For ease of illustration, the drawing shows a basic configuration using two TFTs. The organic EL display comprises such pixels arranged in a matrix.

Referring to the drawing, a gate line 81 extending in the row direction is connected to the gate of an n-channel type TFT 91 which is selected by the gate line 81. A data line 82 extending in the column direction is connected to the drain of the TFT 91. The source of the TFT 91 is connected to a storage capacitor 92 which is connected to a capacity line 83, the other end of which is a low voltage power source.

The node between the source of the TFT 91 and the storage capacitor 92 is connected to the gate of a p-channel type TFT 93. The source of the TFT 93 is connected to a power supply line 84, and the drain of the TFT 93 is connected to an organic EL element 94, the other end of which is connected to a ground connection line 85.

When the gate line 81 is at H level, the TFT 91 is turned on, and at that time, the data from the data line 82 is stored in the storage capacitor 92. The current in the TFT 93 is controlled depending on the data (charge) stored in the storage capacitor 92 and allowed to flow through the organic EL element 94 so that light is emitted.

Specifically, when the TFT 91 is turned on, a signal for the pixel is supplied to the data line 82 so that the storage capacitor 92 is charged in response to the signal supplied to the data line 82, whereby the TFT 93 allows the corresponding current to flow such that the brightness of the organic EL element 94 is controlled. Thus, toning of each pixel is performed by controlling the gate potential of the TFT 93 and by controlling the current allowed to flow through the organic EL element 94.

FIG. 13 is a plan view showing the main part of an organic EL display. The drawing shows a single pixel comprising three sub-pixels 96 to 98 and shows a pixel circuit 95 that includes the TFTs 91 and 93 and the storage capacitor 92 as shown in FIG. 12.

In the organic EL display, the pixel structures are arranged in a matrix.

FIG. 14 is a schematic cross-sectional view of the sub-pixel as shown in FIG. 13. A buffer layer 102 comprising SiO₂ is formed on an insulating substrate 101 comprising a glass substrate, and a channel layer 103 comprising amorphous Si or polycrystalline Si is formed on the buffer layer 102.

A gate electrode 105 is formed on the channel layer 103 through a gate insulating film 104 comprising SiO₂. Source and drain areas 106 and 107 are formed in the channel layer 103 on both sides of the gate electrode 105 to form the TFT 93.

An interlayer insulating film 108 is formed on the buffer layer 102 on which the TFT 93 is formed. A source electrode 111 connected to a source area 106 through a contact hole 109 and a drain electrode 112 connected to a drain area 107 through a contact hole 110 are each formed on the interlayer insulating film 108.

A planarizing insulating film 113 is formed on the interlayer insulating film 108 on which the source and drain electrodes 111 and 112 are formed. A lower electrode 115 that comprises a transparent electrically-conductive film such as ITO connected to the source electrode 111 through a contact hole 114 reaching the source electrode 111, an organic electroluminescent layer 116, and an upper electrode 117 comprising an Al film, a Mg—Ag alloy film or the like are sequentially formed on the planarizing insulating film 113 to form an organic EL element 94.

For example, the organic electroluminescent layer 116 comprises a hole transport layer, a light-emitting layer, and an electron transport layer, which are sequentially stacked.

The light generated by the light-emitting layer of the organic EL element 94 is emitted from the insulating substrate 101 side, because the upper electrode 117 does not have optical transparency, and thus the device is called a bottom emission organic electroluminescent display device.

In the process of manufacturing such an organic EL display, the upper and lower electrodes can short out so that pixel defects can be produced, due to various causes such as dust contamination, a flaw made by a collision between a vapor deposition mask and a substrate, and a residue caused by insufficient cleaning of a substrate. Such an event is described with reference to FIG. 15.

Referring to FIG. 15, if a projection 118 is produced in the lower electrode 115 by a certain cause such as dust and a residue associated with manufacturing processes, the organic electroluminescent layer 116 vapor-deposited thereon can have an extremely thin part at or near the projection 118 so that a short circuit can occur between the upper electrode 117 formed thereon and the lower electrode 115.

Once such pixel defects are visually recognized in a displayed image, they cannot be neglected, and thus the occurrence of defective pixels can significantly reduce the picture quality.

Proposed measures against the pixel defects include a method in which a refractive index-varying region is provided to scatter light such that defective pixels are made inconspicuous (for example, see Japanese Patent Application Laid-Open (JP-A) No. 2004-279464) and a method in which a short circuit in a pixel is irradiated with a laser beam to be isolated (for example, see JP-A No. 2003-178871).

The method disclosed in JP-A No. 2004-279464 has a problem in which a reduction in image quality such as a blurred outline can occur depending on the image. In the method disclosed in JP-A No. 2003-178871, a short circuit can occur at a repaired part, if isolation is not completely achieved by laser irradiation, if it is allowed to stand for a long time, or the like.

### SUMMARY OF THE INVENTION

The present invention has been made in view of the above circumstances and provides an organic electroluminescent display device.

A first aspect of the invention provides an organic electroluminescent display device, comprising: pixels that are divided into at least two segments; current supply lines each independently connected to each of the segments; and active elements that are provided per each pixel and control the connection between an organic electroluminescent element and a power supply line, wherein at least one connection line between a defective segment of the segments and the active element is cut.

A second aspect of the invention provides a method of repairing an organic electroluminescent display device comprising: pixels that are each divided into at least two segments; current supply lines each independently connected to each of the segments; and active elements that are provided per each pixel and control the connection between an organic electroluminescent element and a power supply line, the method comprising cutting at least one connection line between a defective segment of the segments and the active element.

### BRIEF DESCRIPTION OF THE DRAWINGS

FIG. 1 is an illustration of a basic configuration according to the present invention;

FIGS. 2 and 3 are illustrations of a process for manufacturing a bottom emission organic EL display device of Example 1 of the invention;

FIG. 4 is a plan view schematically showing the main part of one sub-pixel;

FIG. 5 is an illustration of how to repair when a pixel defect is found;

FIG. 6 is a plan view schematically showing the main part of one sub-pixel of Example 2 of the invention;

FIG. 7 is an illustration of how to repair when a pixel defect is found;

FIG. 8 is an illustration of a process for manufacturing a top emission organic EL display device of Example 3 of the invention;

FIG. 9 is a plan view schematically showing the main part of one sub-pixel;

FIG. 10 is an illustration of how to repair when a pixel defect is found;

FIG. 11 is a plan view schematically showing the main part of one sub-pixel of Example 4 of the invention;

FIG. 12 is a circuit configuration diagram of a pixel circuit of a conventional organic EL display using TFTs;

FIG. 13 is a circuit configuration diagram of a pixel circuit of a conventional organic EL display using TFTs;

FIG. 14 is a schematic cross-sectional view of the sub-pixel shown in FIG. 13; and

FIG. 15 is an illustration of a conventional pixel defect.

### DETAILED DESCRIPTION OF THE INVENTION

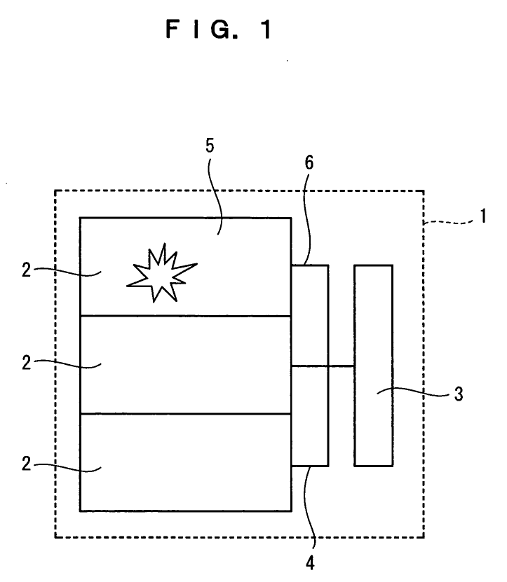

FIG. 1 is a schematic diagram of a basic configuration according to the present invention.

In the drawing, reference numeral 6 represents a cut portion. The invention is directed to an organic electroluminescent display device, including: pixel 1 that is each divided into at least two segments 2; current supply lines each independently connected to each of the segments 2; and active element 3 that is provided per each pixel 1 and control the connection between an organic electroluminescent element and a power supply line, wherein at least one of connection lines 4 between a defective segment 5 of the segments 2 and the active element 3 is cut.

The pixel 1 is divided into two or more segments 2 to which separate current supply lines are connected, respectively, so that even if a defective segment 5 occurs among the segments 2, the cutting of at least one of the connection lines 4 between the defective segment 5 and the active element 3 can eliminate the risk of the occurrence of a short at the repaired portion, and the picture quality is not affected, because the entire pixel can work as an effective pixel.

According to the invention, in the case of a monochrome display device, the pixel 1 itself may be divided into segments, and in a case where the pixel I comprises sub-pixels of different colors, each sub-pixel may be divided into two or more segments.

The pixel 1 may be divided into segments 2 in such a manner that the segments 2 can each be supplied with a current from the same active element 3. Alternatively, the pixel 1 may be divided in such a manner that the segments 2 can each independently connected to an individual active element 3 and each supplied with a current from an individual active element 3.

While it is most reliable to cut the connection line 4 to a power supply line, another connection line 4 to a part other than the power supply line may also be cut in a case where the segments 2 are each independently connected to an individual active element 3.

The repair structure according to the invention may be applied to top emission organic electroluminescent display devices. In this case, a high-aperture-ratio can be provided by allowing the effective pixel part to extend onto the active element 3.

Fusion cutting by laser irradiation or the like is typically used for the cutting with respect to the connection line 4.

According to the invention, each pixel or each sub-pixel (in the case that the pixel comprises sub-pixels of different colors) is divided into two or more segments such that the segments are each supplied with a current from the same active element or such that the segments are each independently connected to an individual active element and each supplied with a current from an individual active element. Separate current supply lines are each connected to each of the segments. At least one connection line between a defective segment of the segments and the active element, typically a connection line to a power supply line, is cut by laser fusion cutting or the like.

### EXAMPLE 1

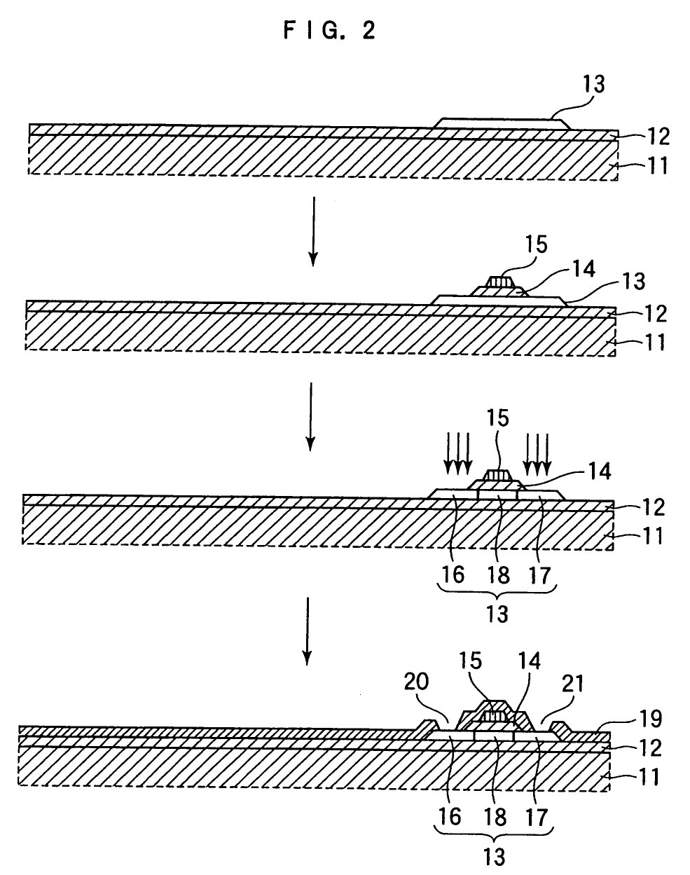

A bottom emission organic EL display device according Example 1 of the invention is described below with reference to FIGS. 2 to 5.

After a buffer layer 12 comprising a SiO₂ film is first formed on an insulating substrate 11 comprising a glass substrate by a CVD method, a polycrystalline silicon layer is deposited by a CVD method, and then an island polycrystalline silicon layer 13 is formed by a conventional photo-etching process.

After a SiO₂ film is deposited over the entire surface by a CVD method, an AlNd film is deposited by sputtering, and then the SiO₂ film and the AlNd film are patterned by a conventional photo-etching process to form a gate insulating film 14 and a gate electrode 15.

Using the gate electrode 15 as a mask, phosphorus ions are implanted, for example, by ion implantation to form source and drain areas 16 and 17 in the island polycrystalline silicon layer 13 on both sides of the gate electrode 15 and to make the remaining portion a channel layer 18.

Thereafter, an interlayer insulating layer 19 comprising a SiN film is deposited over the entire surface by a CVD method, and then contact holes 20 and 21 are formed so as to reach the source and drain areas 16 and 17, respectively, using a conventional photo-etching process.

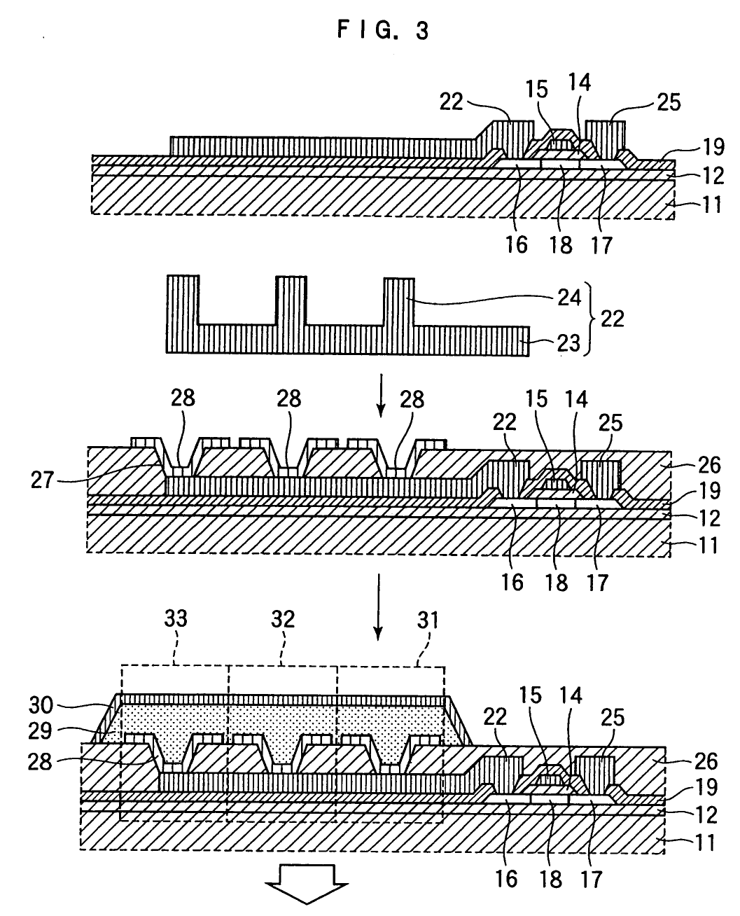

Referring to FIG. 3, thereafter, an electrically conductive layer of an Al/Ti/Al multilayer structure is deposited over the entire surface and then patterned by a conventional photo-etching process to form source and drain electrodes 22 and 25.

As shown in the plan view in the second row, the source electrode 22 is composed of a common source line 23 and three branch lines 24 branched from the line 23. For ease of illustration of the structure of the segments, however, the common source line 23 represents the source electrode 22 in the cross-sectional views.

Thereafter, for example, a photosensitive resin is applied to the entire surface by spin coating to form an interlayer insulating film 26. The interlayer insulating film 26 is exposed to light using a specific mask and then developed with a specific developer so that contact holes 27 are formed for the branch lines 24 of the source electrode 22.

For ease of illustration, the contact holes 27 appear to be formed for the common source line 23 in the drawing.

Thereafter, for example, an ITO film is deposited over the entire surface by sputtering and then patterned into a specific form by a conventional photo-etching process so that lower segmented electrodes 28 are formed which are connected to the branch lines 24 of the source electrode 22 through the contact holes 27, respectively.

Thereafter, an organic EL layer 29 is formed by a mask vapor deposition method such that the layer 29 is placed over the lower segmented electrodes 28 which have been exposed on the bottom of the opening of the pixel. Also using a mask vapor deposition method, an Al film with a thickness of 100 nm, for example, is then deposited over the organic EL layer 29 so that an upper common electrode 30 is formed. The regions corresponding to the lower segmented electrodes 28 form segmented pixel parts 31 to 33, respectively.

In this case, the organic EL layer 29 is formed by stacking a hole injection layer of a 2-TNATA [4,4′,4″-tris(2-naphthylphenylamino)triphenylamine] layer, a hole transport layer of an α-NPD [N,N′-bis(1-naphthyl)-N,N′-diphenyl-1,1′-biphenyl-4,4′-diamine] film, and a light-emitting layer of Alq3 [8-quinolinol aluminum complex)]sequentially from the lower segmented electrode 28 side.

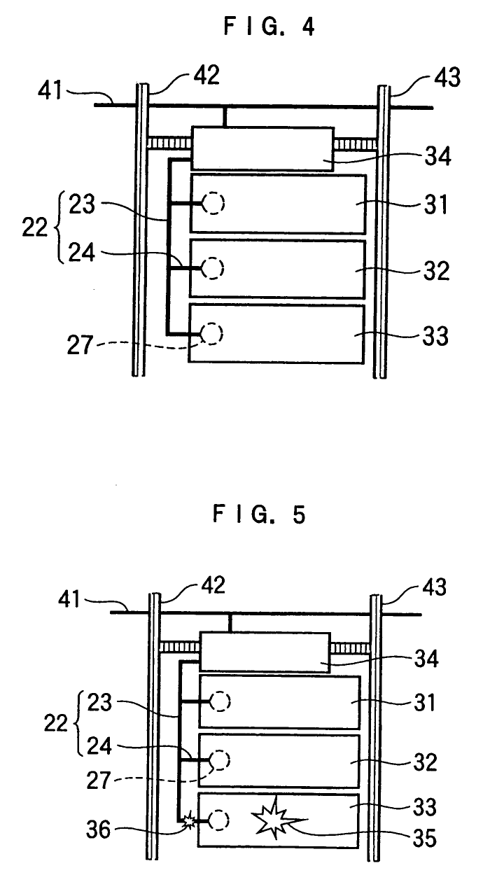

FIG. 4 is a plane view schematically showing the main part of one sub-pixel of the panel prepared by the above process. In this state, a lighting test is performed to determine whether there is any pixel defect caused by a short circuit between the upper common electrode 30 and the lower segmented electrodes 28, which may be due to dust contamination, a flaw made by a collision between the vapor deposition mask and the substrate, a residue caused by insufficient cleaning of the substrate, or the like.

In the segmented pixel parts 31 to 33 having any pixel defect, current leaks from a short circuit portion 35 so that the light cannot be turned on.

FIG. 5 is an illustration of how to repair when a pixel defect is found. Referring to FIG. 5, for example, a laser beam is applied from the insulating substrate 11 side to melt and cut the branch line 24 of the source electrode 22 that connects a pixel circuit 34 to the segmented pixel part 33 causing the pixel defect.

If the segmented pixel part 31, 32 or 33 causing a pixel defect is most distant from the pixel circuit 34, the portion 36 to be molten and cut may not be the branch line 24 but be a part of the common source line 23 near the segmented pixel part 33 causing the pixel defect.

In Example 1 of the invention as shown above, a sub-pixel is divided into segments which are each connected to the pixel circuit so that current leakage can be suppressed by breaking the connection between the pixel circuit and the segmented pixel part causing a pixel defect.

Since the cutting of the line is performed, for example, by laser radiation melting, the short circuit portion 35 is surely isolated so that reliability is ensured for a long period.

In addition, a current larger than usual passes through the two remaining segmented pixel parts 31 and 32, which form an effective pixel, so that the brightness of the entire pixel is not reduced and thus the picture quality is not degraded.

### EXAMPLE 2

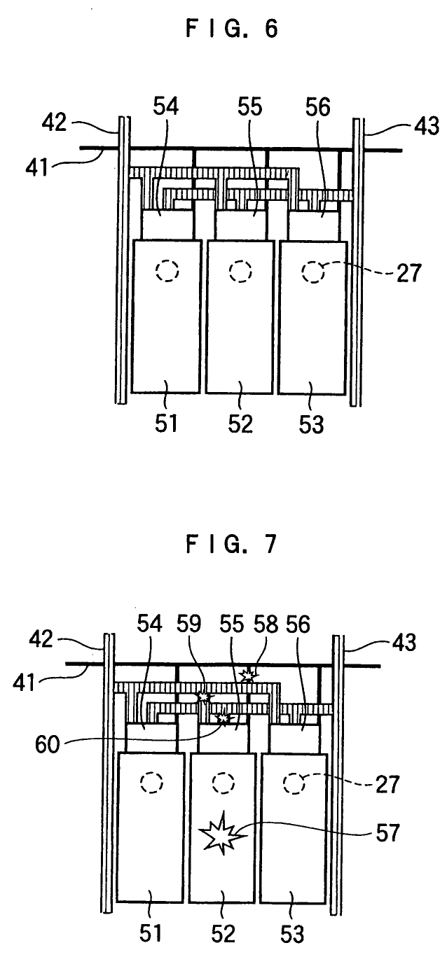

A bottom emission organic EL display device according to Example 2 of the invention is described with reference to FIGS. 6 and 7. Plan views only are provided, since the element structure itself is the same as a conventional structure.

FIG. 6 is a plan view schematically showing the main part of one sub-pixel according to Example 2 of the invention, in which one conventional sub-pixel structure is segmented into three segmented pixel parts 51 to 53, which are each connected to the same gate line 41, data line 42, and power supply line 43 through segmented pixel circuits 54 to 56 each containing an independent TFT.

FIG. 7 is an illustration of how to repair when any pixel defect is found. When a pixel defect is found by a lighting test in the same manner as Example 1, all or any of the connections to the gate line 41, the data line 42 and the power supply line 43 is cut by laser fusion cutting such that the TFT of the pixel circuit 55 connected to the segmented pixel part 52 causing the pixel defect cannot work.

The drawing shows a case where all the connections are cut.

In Example 2, reliability is also ensured for a long period in the same manner as Example 1, and the picture quality is not degraded.

In Example 2 having segmented pixel circuit parts, even when a short circuit is caused by a pixel circuit defect, repairs can also be made similarly to the case of the defect of the pixel part.

### EXAMPLE 3

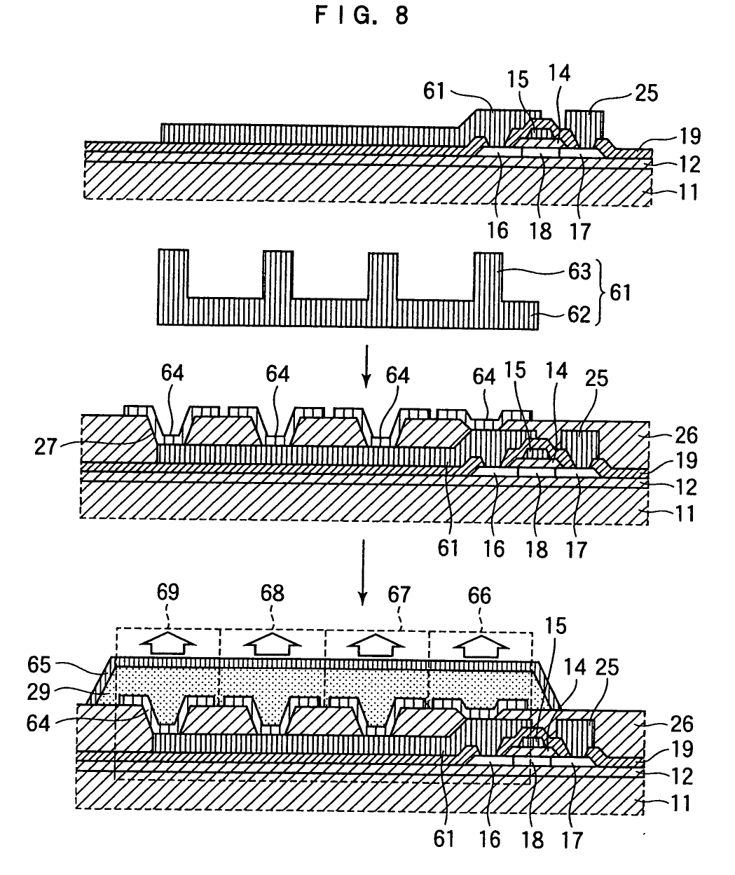

A top emission organic EL display device according Example 3 of the invention is described with reference to FIGS. 8 to 10.

Referring to FIG. 8, a TFT is first formed on an insulating substrate 11 through a buffer layer 12 in the same manner as Example 1. After an interlayer insulating layer 19 comprising a SiN film is deposited over the entire surface, contact holes are formed so as to reach source and drain areas 16 and 17, respectively, using a conventional photo-etching process.

Thereafter, an electrically conductive layer of an Al/Ti/Al multilayer structure is deposited over the entire surface and then patterned by a conventional photo-etching process to form a source electrode 61 also extending onto the TFT part and to form a drain electrode 25.

As shown in the plan view in the second row, the source electrode 61 is composed of a common source line 62 and four branch lines 63 branched from the line 62. For ease of illustration of the structure of the segments, however, the common source line 62 represents the source electrode 61 in the cross-sectional views.

Thereafter, a photosensitive resin is applied to the entire surface by spin coating to form an interlayer insulating film 26. The interlayer insulating film 26 is exposed to light using a specific mask and then developed with a specific developer so that contact holes 27 are formed for the branch lines 63 of the source electrode 61. For ease of illustration, the contact holes 27 appear to be formed for the common source line 61 in the drawing.

Thereafter, an Al film is deposited over the entire surface by sputtering and then patterned into a specific form by a conventional photo-etching process so that lower segmented electrodes 64 are formed which are connected to the branch lines 63 of the source electrode 61 through the contact holes 27, respectively.

Thereafter, an organic EL layer 29 is formed by a mask vapor deposition method such that the layer 29 is placed over the lower segmented electrodes 64 that have been exposed on the bottom of the opening of the pixel. Also using a mask vapor deposition method, a 10 nm-thick Al film and a 30 nm-thick ITO film, for example, are sequentially deposited over the organic EL layer 29 so that an upper common electrode 65 is formed. The regions corresponding to the lower segmented electrodes 64 form segmented pixel parts 66 to 69, respectively.

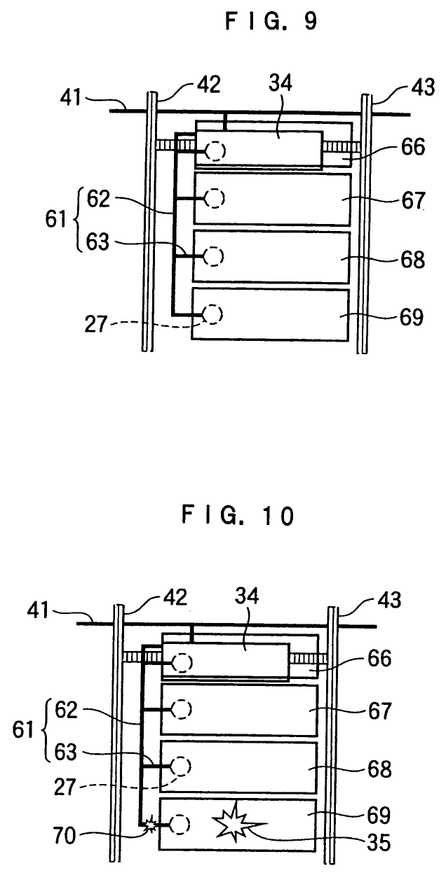

FIG. 9 is a plane view schematically showing the main part of one sub-pixel of the panel prepared by the above process. In this state, a lighting test is performed to determine whether there is any pixel defect caused by a short circuit between the upper common electrode 65 and the lower segmented electrodes 64, which may be due to dust contamination, a flaw made by a collision between the vapor deposition mask and the substrate, a residue caused by insufficient cleaning of the substrate, or the like.

FIG. 10 is an illustration of how to repair when a pixel defect is found. Referring to FIG. 10, for example, a laser beam is applied from the insulating substrate 11 side to melt and cut the branch line 63 of the source electrode 61 that connects a pixel circuit 34 to the segmented pixel part 69 causing the pixel defect, so that current leakage can be suppressed.

In Example 3, reliability is also ensured for a long period in the same manner as Example 1, and the picture quality is not degraded. In Example 3, the top emission type further including the segmented pixel part 66 on the pixel circuit part can provide a large numerical aperture.

### EXAMPLE 4

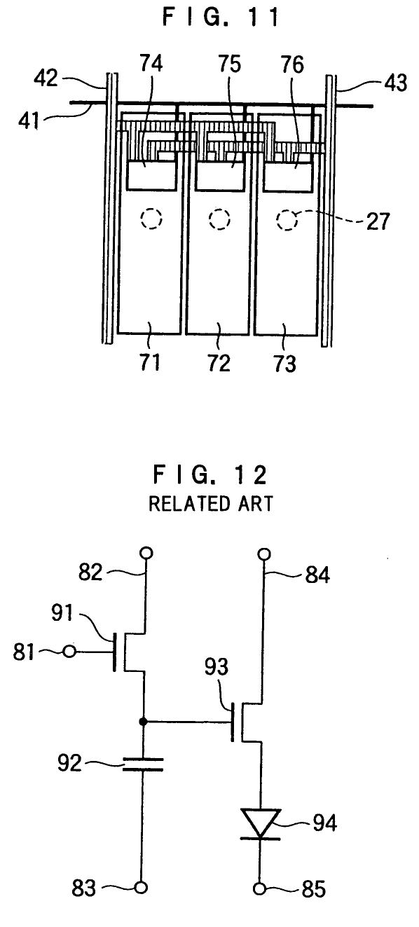

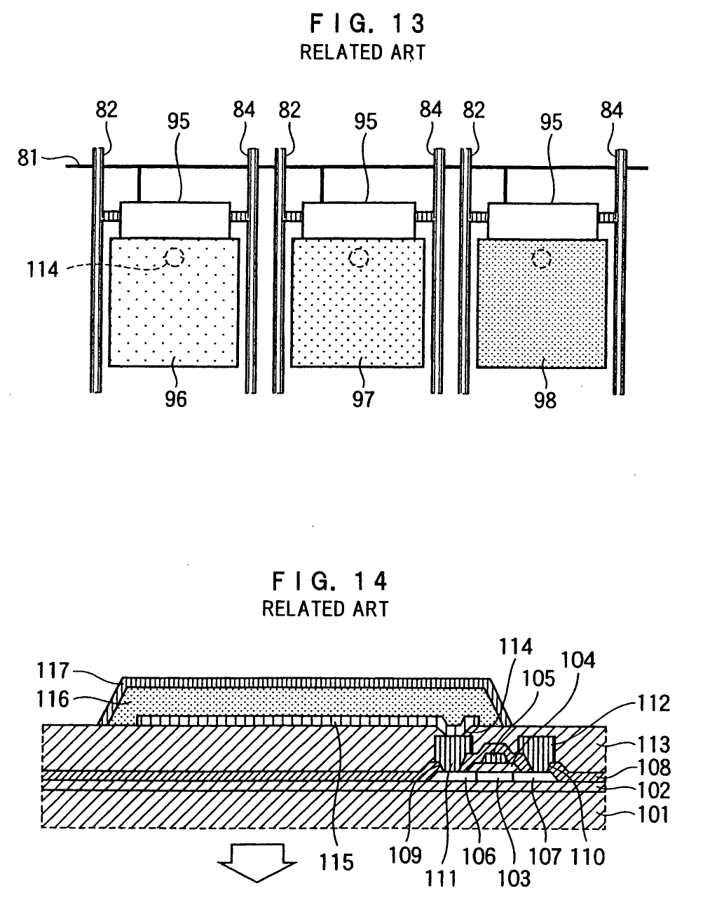

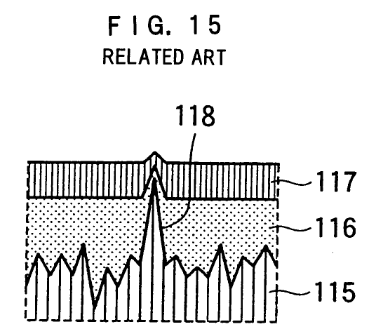

A top emission organic EL display device according Example 4 of the invention is described with reference to FIG. 11. Only a plan view is provided for showing the structure of the device other than the conventional structure.

FIG. 11 is a plan view schematically showing the main part of one sub-pixel according to Example 4 of the invention, in which one conventional sub-pixel structure is segmented into three segmented pixel parts 71 to 73, which are each connected to the same gate line 41, data line 42, and power supply line 43 through segmented pixel circuits 74 to 76 each containing an independent TFT.

If a pixel defect is found, all or any of the connections to the gate line 41, the data line 42 and the power supply line 43 may be cut by laser fusion cutting in the same manner as Example 2 such that the TFT of the pixel circuit 74, 75 or 76 connected to the segmented pixel part 71, 72 or 73 causing the pixel defect cannot work.

In Example 4, reliability over a long period is also ensured in the same manner as Example 1, and the picture quality is not degraded. In the same manner as Example 2, even when a short circuit is caused by a pixel circuit defect, repairs can also be made similarly to the case of a defect of a pixel part. In the same manner as Example 3, an effective pixel region is also provided on the pixel circuit part so that a high-aperture-ratio can be provided.

While the invention is described with reference to each example above, it should be understood that the invention is not limited to the conditions or structures described in each example and that a variety of modifications are possible. For example, the materials and layered structures that form the organic EL layer as described in each example above are only a mere example, and the materials for the organic layer may be selected from known organic EL materials as needed depending on luminescent color.

In each example, the island silicon layer of the TFT comprises a polycrystalline silicon layer deposited by a CVD method. Alternatively, an amorphous silicon film may be formed and then crystallized into a polycrystalline silicon film by laser annealing or the like.

One sub-pixel is divided into three parts in Example 1, 2 or 4 and into four parts in Example 3. Alternatively, for example, one sub-pixel may be divided into two parts.

While ITO is used for the lower segmented electrode in Example 1 or 2, the material for the electrode is not limited to ITO and may be any other electrically-conductive oxide material having optical transparency similarly to ITO, such as IZO or ZnO.

While Al is used for the lower segmented electrode in Example 3 or 4, the material for the electrode is not limited to Al and may be any other metal such as AlNd and Mo or an electrically-conductive oxide material such as ITO, IZO or ZnO.

While in each example above, there is no reference to when the lighting test is performed, it may be performed immediately after the upper common electrode is formed or after a second substrate comprising a glass substrate is bonded with a UV adhesive to the insulating substrate 11.

While TFT is used as an active element in each example above, the active element is not limited to TFT but, for example, may be any other three-terminal switching element.

A full color display device with a combination of RGB light-emitting elements is described in each example above. Alternatively, a mono-color display device or a color display device with any appropriate combination of different colors may be provided.

Illustrative embodiments of the invention are listed below with reference to FIG. 1 again.

(1) An organic electroluminescent display device, comprising: pixel 1 that is each divided into at least two segments 2; current supply lines each independently connected to each of the segments 2; and active element 3 that is provided per each pixel 1 and control the connection between an organic electroluminescent element and a power supply line, wherein at least one connection line 4 between a defective segment 5 of the segments 2 and the active element 3 is cut.

(2) The organic electroluminescent display device according to Item (1), wherein the pixel 1 comprises sub-pixels of different colors, and each of the sub-pixels is divided into two segments or more.

(3) The organic electroluminescent display device according to Item (1) or (2), wherein the segments 2 are each connected to the same active element 3 and supplied with a current from the same active element 3.

(4) The organic electroluminescent display device according to Item (1) or (2), wherein separate active elements 3 are each independently connected to an individual active element, and each of the segments 2 is supplied with a current from the individual active elements 3.

(5) The organic electroluminescent display device according to Item (3) or (4), wherein the cut connection line 4 is to the power supply line.

(6) The organic electroluminescent display device according to Item (4), wherein the cut connection line 4 is to a part other than the power supply line.

(7) The organic electroluminescent display device according to any one of Items (1) to (6), wherein the organic electroluminescent element is a top emission organic electroluminescent element from which light is emitted from an upper electrode direction, and effective pixel parts also extend over the active element 3.

(8) The organic electroluminescent display device according to any one of Items (1) to (7), wherein the cut portion 6 with respect to the connection line 4 is formed by fusion cutting.

(9) A method of repairing an organic electroluminescent display device comprising: pixels that are each divided into at least two segments; current supply lines each independently connected to each of the segments; and active elements that are provided per each pixel and control the connection between an organic electroluminescent element and a power supply line, the method comprising cutting at least one connection line between a defective segment of the segments and the active element.

(10). A method of repairing an organic electroluminescent display device according to Item (9), the method comprising cutting the connection line between a defective segment of the pixel segments and the active element by fusion.

According to the invention, a defective part of a pixel is isolated by cutting a connection line so that repairs on the pixel defect can be surely made, and the remaining segments form effective pixels for emission and display so that influence on the picture quality can be prevented.

For example, the invention is typically applied to two-dimensional matrix display devices. However, the application is not limited to matrix display devices but also include a large single light source such as a light source for mood lighting.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. An organic electroluminescent display device, comprising:
pixels that are each divided into at least two segments;
current supply lines each independently connected to each of the segments; and
active elements that are provided per each pixel and control the connection between an organic electroluminescent element and a power supply line, wherein
at least one connection line between a defective segment of the segments and the active element is cut.

2. The organic electroluminescent display device according to claim 1, wherein the pixels comprise sub-pixels of different colors, and each of the sub-pixels is divided into at least two of the segments.

3. The organic electroluminescent display device according to claim 1, wherein the organic electroluminescent element is a top emission organic electroluminescent element from which light is emitted from an upper electrode direction, and effective pixel parts also extend over the active elements.

4. The organic electroluminescent display device according to claim 1, wherein the cut portion with respect to the connection line is formed by fusion cutting.

5. The organic electroluminescent display device according to claim 2, wherein the organic electroluminescent element is a top emission organic electroluminescent element from which light is emitted from an upper electrode direction, and effective pixel parts also extend over active elements.

6. An organic electroluminescent display device, comprising:
pixels that are each divided into at least two segments; and
active elements that are provided per each pixel and control the connection between an organic electroluminescent element and a power supply line, wherein
the segments are each connected to the same active element and supplied with a current from the same active element, and
at least one connection line between a defective segment of the segments and its corresponding active element is cut.

7. The organic electroluminescent display device according to claim 6, wherein the pixels comprises sub-pixels of different colors, and each of the sub-pixels is divided into at least two of the segments.

8. The organic electroluminescent display device according to claim 6, wherein the organic electroluminescent element is a top emission organic electroluminescent element from which light is emitted from an upper electrode direction, and effective pixel parts also extends over active elements.

9. The organic electroluminescent display device according to claim 6, wherein the cut connection line is to the power supply line.

10. The organic electroluminescent display device according to claim 6, wherein the cut portion with respect to the connection line is formed by fusion cutting.

11. The organic electroluminescent display device according to claim 9, wherein the organic electroluminescent element is a top emission organic electroluminescent element from which light is emitted from an upper electrode, and an effective pixel parts also extend over the active elements.

12. The organic electroluminescent display device according to claim 1,wherein the segments are each independently connected to an individual active element and each of the segments is supplied with a current from the individual active element.

13. The organic electroluminescent display device according to claim 12, wherein the pixel comprises sub-pixels of different colors, and each of the sub-pixels is divided into two of the segments or more.

14. The organic electroluminescent display device according to claim 12, wherein the organic electroluminescent element is a top emission organic electroluminescent element from which light is emitted from an upper electrode direction, and effective pixel parts also extend over the active elements.

15. The organic electroluminescent display device according to claim 12, wherein the cut connection line is to the power supply line.

16. The organic electroluminescent display device according to claim 12, wherein the cut connection line is to a part other than the power supply line.

17. The organic electroluminescent display device according to claim 12, wherein the cut portion with respect to the connection line is formed by fusion cutting.

18. The organic electroluminescent display device according to claim 15, wherein the organic electroluminescent element is a top emission organic electroluminescent element from which light is emitted from an upper electrode direction, and effective pixel parts also extend over the active elements.

19. A method of repairing an organic electroluminescent display device comprising: pixels that are each divided into at least two segments; current supply lines each independently connected to each of the segments; and active elements that are provided per each pixel and control the connection between an organic electroluminescent element and a power supply line, the method comprising cutting at least one connection line between a defective segment of the segments and the active element.

20. A method of repairing an organic electroluminescent display device according to claim 19, the method comprising cutting the connection line between a defective segment of the pixel segments and the active element by fusion.
